(19) United States
(12) Patent Application Publication
(10) Pub. No.: US 2013/0027430 A1
(43) Pub. Date: Jan. 31, 2013

(54) IMAGE PROCESSING DEVICE, IMAGE PROCESSING METHOD AND PROGRAM

(71) Applicants: Kouichi Matsuda, Tokyo (JP); Masaki Fukuchi, Tokyo (JP)

(72) Inventors: Kouichi Matsuda, Tokyo (JP); Masaki Fukuchi, Tokyo (JP)

(21) Appl. No.: 13/640,913

(22) PCT Filed: Apr. 6, 2011
(86) PCT No.: PCT/JP2011/002044

§ 371 Date: Oct. 12, 2012

(30) Foreign Application Priority Data
Apr. 19, 2010 (JP) 2010-095845

(51) Int. Cl. G09G 5/377

(52) U.S. Cl. 345/633

(57) ABSTRACT

A method is provided for superimposing schedule data on a temporal measurement object. The method comprises receiving image data representing an input image. The method further comprises detecting the presence of a temporal measurement object in the input image based on features of the temporal measurement object detected in the image data. The method further comprises providing, in response to detection of the presence of the temporal measurement object in the input image, schedule data for superimposing on a user's view of the temporal measurement object.

### TECHNICAL FIELD

The present disclosure relates to an image processing device, an image processing method and a program.

### BACKGROUND ART

Electronic equipment for assisting personal schedule management task has been widely used irrespective of whether it is for business use or for personal use. For example, a commonly used PDA (Personal Data Assistance) and a smart phone are typically equipped with some sort of applications for schedule management. There are quite a lot of cases where an application for managing schedule is used on a PC (Personal Computer).

Many types of the above-mentioned electronic equipment are equipped with a communication function in addition to a schedule management function. A user, therefore, transmits schedule data to other user's equipment, so that he/she may share schedule with other user or coordinate schedule. Moreover, as examples of technology for sharing or exchanging schedule among users, technology described in the following patent literatures 1 and 2 is known.

### CITATION LIST

### Patent Literature

PTL 1: Japanese Patent Application Laid-Open No. 2005-004307
PTL 2: Japanese Patent Application Laid-Open No. 2005-196493

### SUMMARY OF INVENTION

### Technical Problem

However, in the above-described prior art, a schedule is displayed on a screen of electronic equipment. For this reason, it was not easy for a plurality of users to coordinate schedules, referring to the same calendar (pointing at it depending upon the situation) when using portable or small-sized equipment. Moreover, there was the issue that when projecting an image on a screen using a projector, not only schedule to be shared but also even private schedule are viewed by other users. On the other hand, a method for managing schedule using a physical calendar without being assisted by the electronic equipment had an advantage of being free from the restriction imposed on a screen of the electronic equipment, but was accompanied by difficulty that writing schedule in a calendar was necessary and changing the schedule or sharing information was troublesome.

Accordingly, it is desirable to provide a novel and improved image processing device, an image processing method and a program which allow a plurality of users to share or coordinate schedule easily using a physical calendar.

### Solution to Problem

Accordingly, there is provided an apparatus for superimposing schedule data on a temporal measurement object. The apparatus comprises a receiving unit for receiving image data representing an input image. The apparatus further comprises a detecting unit for detecting the presence of a temporal measurement object in the input image based on features of the temporal measurement object detected in the image data. The apparatus further comprises an output device for outputting, in response to detection of the presence of the temporal measurement object in the input image, schedule data for superimposing on a user's view of the temporal measurement object.

In another aspect, there is provided a method for superimposing schedule data on a temporal measurement object. The method comprises receiving image data representing an input image. The method further comprises detecting the presence of a temporal measurement object in the input image based on features of the temporal measurement object detected in the image data. The method further comprises providing, in response to detection of the presence of the temporal measurement object in the input image, schedule data for superimposing on a user's view of the temporal measurement object.

In another aspect, there is provided a tangibly embodied non-transitory computer-readable storage medium containing instructions which, when executed by a processor, cause a computer to perform a method for superimposing schedule data on a temporal measurement object. The method comprises receiving image data representing an input image. The method further comprises detecting the presence of a temporal measurement object in the input image based on features of the temporal measurement object detected in the image data. The method further comprises providing, in response to detection of the presence of the temporal measurement object in the input image, schedule data for superimposing on a user's view of the temporal measurement object.

In another aspect, there is provided an apparatus for superimposing schedule data on a temporal measurement object. The apparatus comprises a first receiving unit for receiving image data representing an input image, the input image including a temporal measurement object. The apparatus further comprises a second receiving unit for receiving schedule data for superimposing on a user's view of the temporal measurement object. The apparatus further comprises a generating unit for generating display information for displaying the received schedule data superimposed on the user's view of the temporal measurement object.

In another aspect, there is provided a system. The system comprises an image processing unit configured to obtain image data representing an input image, and to generate display information of schedule data superimposed on a user's view of a temporal measurement object. The system further comprises a detecting unit configured to detect the presence of a temporal measurement object in the input image based on features of the temporal measurement object in the image data, and to provide, in response to detection of the presence of the temporal measurement object in the input image, schedule data to the image processing apparatus for superimposing on the user's view of the temporal measurement object.

### Advantageous Effects of Invention

As described above, an image processing device, an image processing method and a program according to certain disclosed embodiments allow a plurality of users to share or coordinate schedule easily using a physical calendar.

### BRIEF DESCRIPTION OF DRAWINGS

FIG. 1 is a schematic view illustrating the outline of an image processing system according to one embodiment.

FIG. 2 is a block diagram illustrating one example of configuration of an image processing device according to one embodiment.

FIG. 3 is a block diagram illustrating one example of configuration of a learning device according to one embodiment.

FIG. 4 is an illustrative view showing the learning processing according to one embodiment.

FIG. 5 is an illustrative view showing one example of feature amount common to calendars.

FIG. 6 is an illustrative view showing one example of input image.

FIG. 7 is an illustrative view showing one example of sets of feature amount corresponding to eye directions.

FIG. 8 is an illustrative view showing one example of result of detection of the calendar.

FIG. 9 is an illustrative view showing one example of schedule data.

FIG. 10 is an illustrative view showing the first example of an output image according to one embodiment.

FIG. 11 is an illustrative view showing the second example of an output image according to one embodiment.

FIG. 12 is an illustrative view showing a gesture recognition processing according to one embodiment.

FIG. 13 is a flowchart illustrating one example of image processing flow according to one embodiment.

FIG. 14 is a flowchart illustrating one example of gesture recognition processing flow according to one embodiment.

### DESCRIPTION OF EMBODIMENTS

Hereinafter, embodiments will be described in detail with reference to the appended drawings. Note that, in this specification and the appended drawings, structural elements that have substantially the same function and structure are denoted with the same reference numerals, and repeated explanation of these structural elements is omitted.

Moreover, the “Description of Embodiments” will be described according to the following order.

1. Outline of system

2. Configuration example of image processing device

3. Image processing flow

4. Summary

<1. Outline of System>

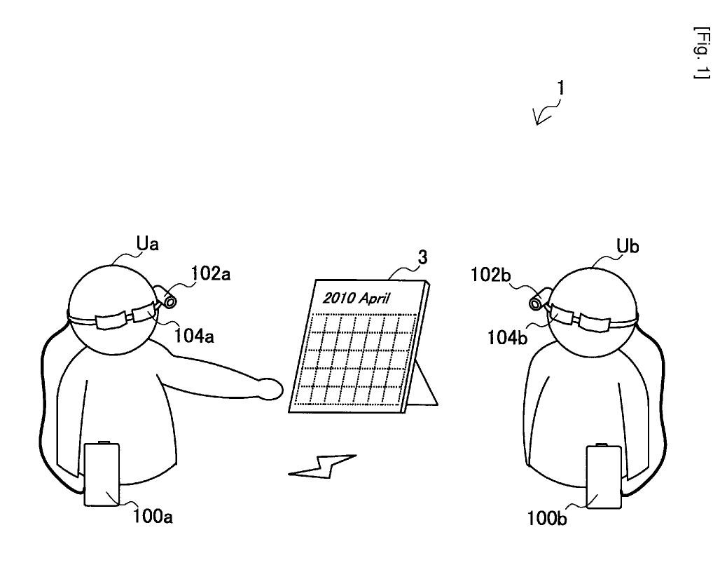

Firstly, the outline of an image processing device according to one embodiment will be described with reference to FIG. 1. FIG. 1 is a schematic view illustrating the outline of an image processing system 1 according to one embodiment. Referring to FIG. 1, the image processing system 1 includes an image processing device 100a used by a user Ua and an image processing device 100b used by a user Ub.

The image processing device 100a is connected with, for example, an imaging device 102a and a head mounted display (HMD) 104a mounted on a head of the user Ua. The imaging device 102a is directed toward an eye direction of the user Ua, images a real world and outputs a series of input images to the image processing device 100a. The HMD 104a displays an image input from the image processing device 100a to the user Ua. The image displayed by the HMD 104a is an output image generated by the image processing device 100a. The HMD 104a may be a see-through type display or a non-see through type display.

The image processing device 100b is connected with, for example, an imaging device 102b and a head mount display (HMD) 104b mounted on a head of the user Ub. The imaging device 102b is directed toward an eye direction of the user Ub, images a real world and outputs a series of input images to the image processing device 100b. The HMD 104b displays an image input from the image processing device 100b to the user Ub. The image displayed by the HMD 104b is an output image generated by the image processing device 100b. The HMD 104b may be a see-through type display or a non-see through type display.

The image processing devices 100a and 100b may be communicated with each other via a wired communication connection or a radio communication connection. Communication between the image processing device 100a and the image processing device 100b may be directly made via, for example, P2P (Peer to Peer) method or indirectly made via other devices such as a router or a server (not shown).

In an example of FIG. 1, a calendar 3 (i.e., a temporal measurement object) existing in a real world is illustrated between the user Ua and the user Ub. As will be described later in detail, the image processing device 100a generates an output image obtained by superimposing information elements about schedule owned by the user Ua on the calendar 3. It is to be appreciated that in certain embodiments, different temporal measurement objects may be used in place of calendar 3. For example, temporal measurement objects may include a clock, a timepiece (e.g., a watch), a timetable, or other such objects used for temporal measurement. Similarly, the image processing device 100b generates an output image obtained by superimposing information elements about schedule owned by the user Ub on the calendar 3. Moreover, in the present embodiment, a simple interface used for exchanging schedule data between the image processing device 100a and the image processing device 100b is introduced as described in detail later.

In addition, the image processing device 100a and the image processing device 100b are not limited to an example illustrated in FIG. 1. For example, the image processing device 100a or 100b may be realized using a mobile terminal with a camera. In that case, the mobile terminal with a camera images the real world and an image processing is performed by the terminal and then an output image is displayed on a screen of the terminal. Moreover, the image processing device 100a or 100b may be other types of devices including a PC (Personal Computer) or a game terminal. For example, in certain embodiments, image processing device 100a or 100b may be remote servers connected to a network, such as the Internet. The remote servers may performs steps of receiving image data via the network and detecting calendar 3 in the image data. The remote server may then provide schedule data to, for example, imaging device 102b or HMD 104b.

In the following description in the present specification, when it is not necessary to distinguish the image processing device 100a from the image processing device 100b, the image processing devices 100a and 100b are collectively referred to an image processing device 100 by omitting alphabetical letters which are final symbols. Moreover, the same shall apply to the imaging devices 102a and 102b (an imaging device 102), HMDs 104a and 104b (an HMD 104), and other elements. The number of the image processing devices 100 that can participate in an image processing system 1 is not limited to the number illustrated in an example in FIG. 1, but may be three or more. Namely, for example, the third image processing device 100 used by the third user may be further included in the image processing system 1.

<2. Configuration Example of Image Processing Device>

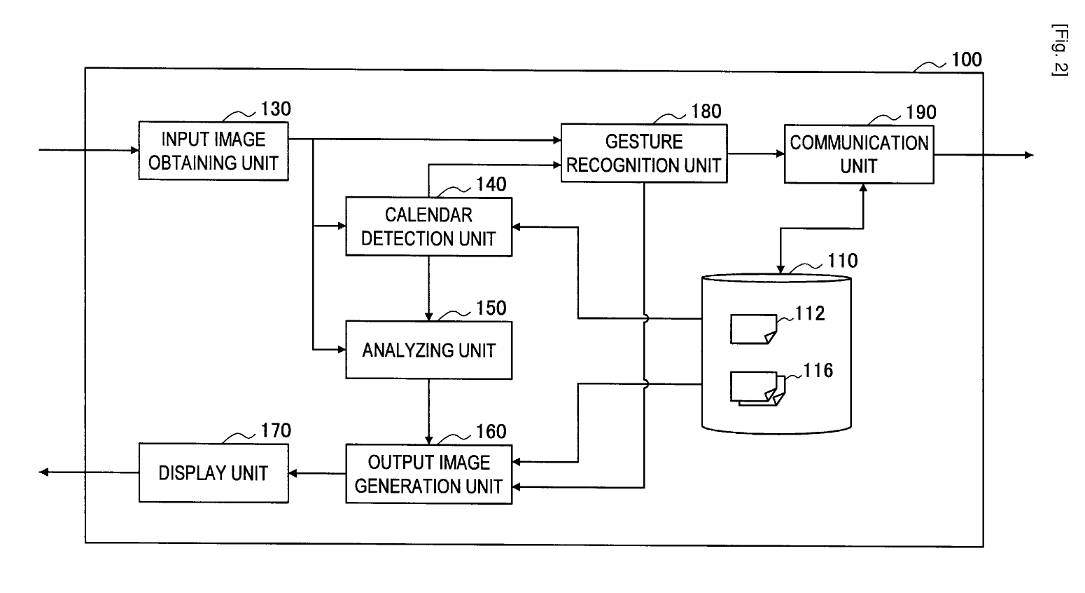

Next, with reference to FIG. 2 to FIG. 12, configuration of the image processing system 100 according to the present embodiment will be described. FIG. 2 is a block diagram illustrating one example of configuration of the image processing device 100 according to the present embodiment. Referring to FIG. 2, the image processing device 100 comprises a storage unit 110, an input image obtaining unit 130 (i.e., a receiving unit), a calendar detection unit 140, an analyzing unit 150, an output image generation unit 160 (i.e., an output device or output terminal), a display unit 170, a gesture recognition unit 180 and a communication unit 190. As used herein, the term “unit” may be a software module, a hardware module, or a combination of a software module and a hardware module. Furthermore, in certain embodiments, various units of image processing device 100 may be embodied in one or more devices or servers. For example, calendar detection unit 140, analyzing unit 150, or output image generation unit 160 may be embodied in different devices.

(Storage Unit)

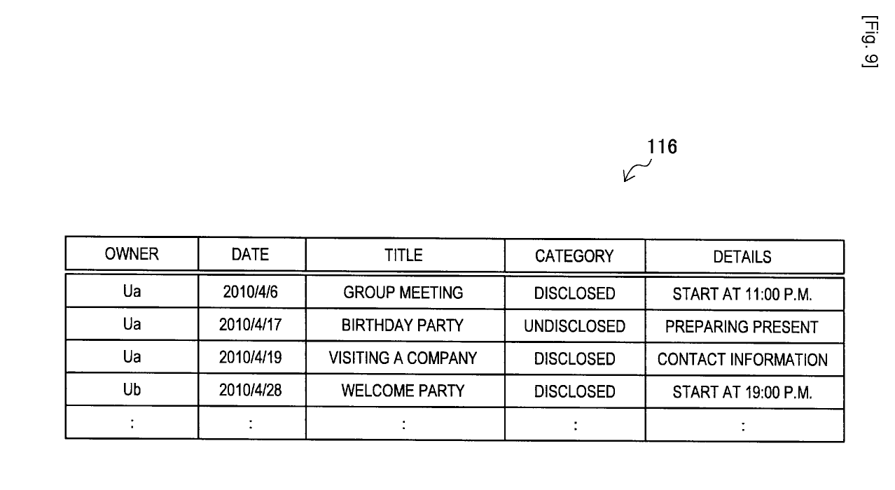

The storage unit 110 stores a program or data used for an image processing performed by the image processing device 100 using memory medium such as a hard disk or a semiconductor memory. For example, data stored by the storage unit 110 includes feature amount common to calendars 112 indicating feature in appearance common to a plurality of calendars. The feature amount common to calendars is obtained through preliminary learning processing using a calendar image and a non-calendar image as a teacher image. Moreover, data stored by the storage unit 110 includes schedule data 116 in the form of a list of dated information. One example of the schedule date will be described later with reference to FIG. 9.

(Feature Amount Common to Calendars)

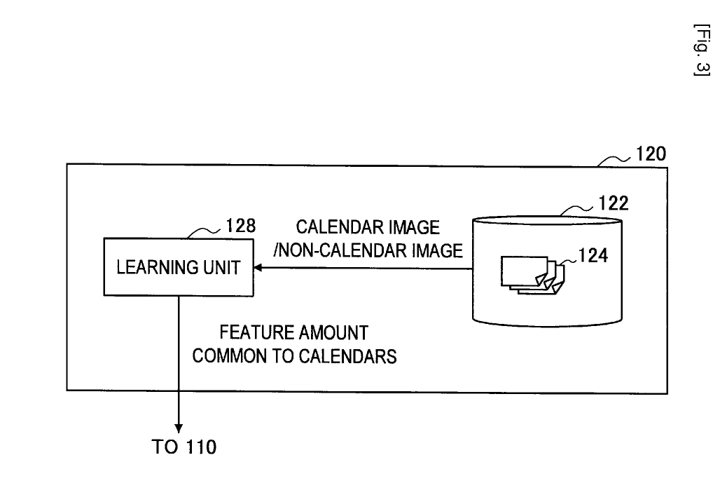

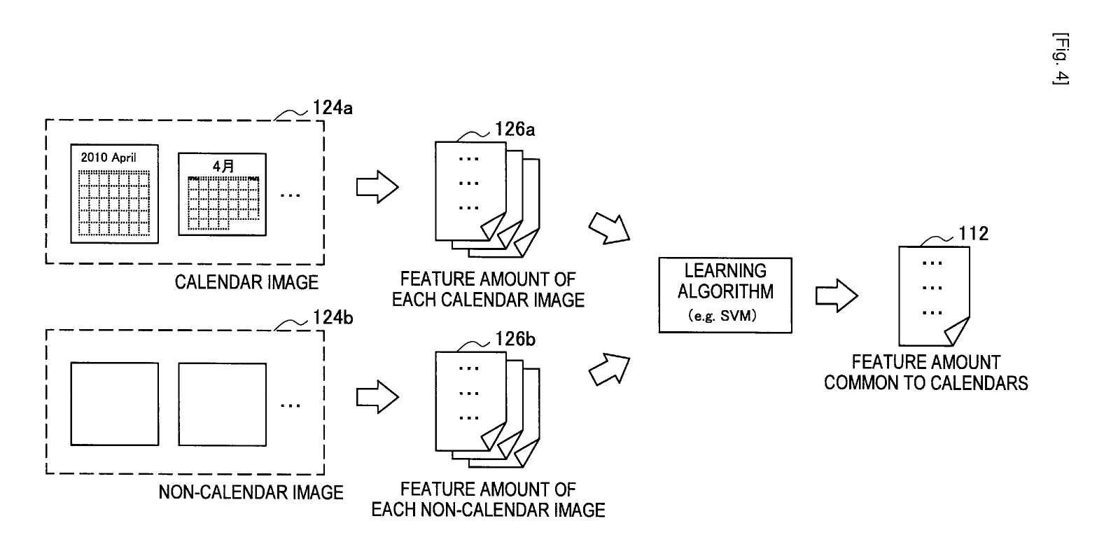

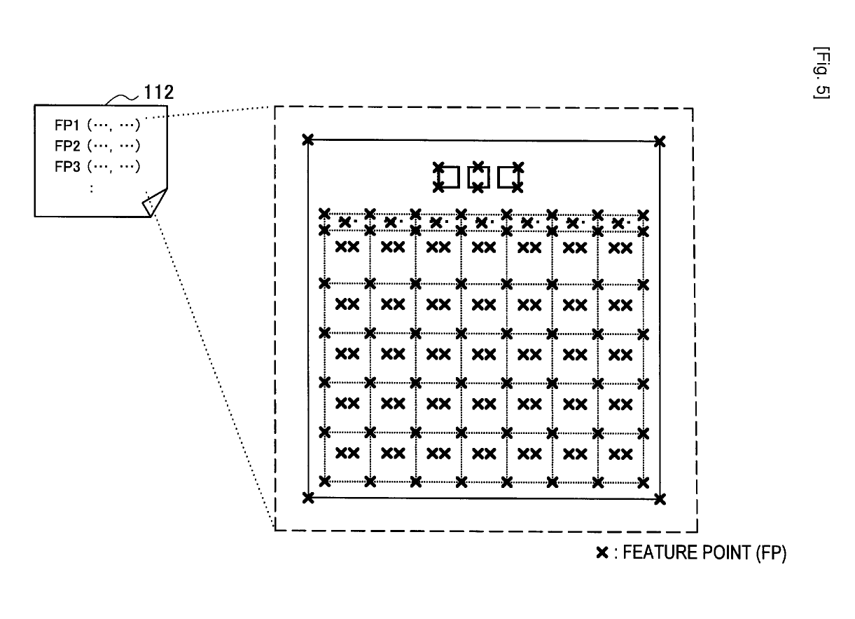

FIG. 3 is a block diagram illustrating one example of configuration of the leaning device 120 for obtaining feature amount common to calendars 112 preliminarily stored by the storage unit 110. FIG. 4 is an illustrative view showing a learning processing performed by the learning device 120. FIG. 5 is an illustrative view showing one example of the feature amount common to calendars 112 obtained as a result of the learning processing.

Referring to FIG. 3, the learning device 120 comprises a memory for learning 122 and a learning unit 128. The learning device 120 may be part of the image processing device 100, or a different device from the image processing device 100.

The memory for learning 122 preliminarily stores a group of teacher data 124. The teacher data 124 includes a plurality of calendar images, each of which shows the real-world calendar and a plurality of non-calendar images, each of which shows an object other than the calendar. The memory for learning 122 outputs the group of teacher data 124 to the learning unit 128 when the learning unit 120 performs a leaning processing.

The learning unit 128 is a publicly known teacher such as an SVM (Support Vector Machine) or a neural network and determines feature amount common to calendars 112 indicating feature in appearance common to a plurality of calendars according to a learning algorithm. Data input for the learning processing input by the learning unit 128 is feature amount set in each of the above-described group of teacher data 124. More specifically, the learning unit 128 sets a plurality of feature points in each of teacher images and uses a coordinate of feature points as at least part of the feature amount of each of the teacher images. Data output as a result of the learning processing includes coordinates of a plurality of feature points set on an appearance of an abstract calendar (namely, appearance common to many calendars).

The outline of the learning processing flow performed by the learning unit 128 is illustrated in FIG. 4. On upper left in FIG. 4, a plurality of calendar images 124a included in a group of teacher date 124 are illustrated. At first, the learning unit 128 sets a plurality of feature points in each of the plurality of calendar images 124a. A method of setting the feature points may be an arbitrary method, for example, a method using a known Harris operator or a Moravec operator or a FAST feature detection method. Subsequently, the learning unit 128 determines feature amount of each calendar image 126 in accordance with set feature points. The feature amount of each calendar image 126a may include additional parameter values such as brightness, contrast and direction of each feature point in addition to a coordinate of each feature point. By using distinctive invariant Features described in “Distinctive Image Features from Scale-Invariant Keypoints” (the International Journal of Computer Vision, 2004) by David G. Lowe as the feature amount, high robustness against noise in an image, variation in size, rotation and variation in illumination during the calendar detection processing described later will be realized. On the lower left side in FIG. 4, a plurality of non-calendar images 124b included in a group of teacher data 124 are illustrated. The learning unit 128 sets feature points in such plurality of non-calendar images 124b and determines the feature amount of each non-calendar image 126b in the same way. Subsequently, the learning unit 128 sequentially inputs the feature amount of each calendar image 126a and the feature amount of each non-calendar image 126b in the learning algorithm. As a result of repetition of machine-learning, the feature amount common to calendars 112 is worked out and the feature amount common to calendars 112 is obtained.

Referring to FIG. 5, contents of the feature amount common to calendars 112 are illustrated conceptually. Generally, many of calendars (especially, a monthly calendar) have a label indicating a year and month, a heading of days of the week and a frame of each date. In an example of FIG. 5, therefore, the feature amount common to calendars 112 includes a coordinate of feature points which correspond to a corner of a label indicating a month and year, a corner of a heading of days of the week, a corner of a frame of each date and a corner of a calendar itself, respectively. In addition, an example of the feature amount common to calendars 112 mainly used for detecting a monthly calendar is illustrated here. However, the learning processing of each type of calendars, such as a monthly calendar, a weekly calendar and a calendar showing the whole one year, may be performed and the feature amount common to calendars 112 of each type of calendars may be obtained.

The storage unit 110 preliminarily stores the feature amount common to calendars 112 obtained as a result of such learning processing. The storage unit 110 then outputs the feature amount common to calendars 112 to a calendar detection unit 140 when the image processing is performed by the image processing device 100.

(Input Image Obtaining Unit)

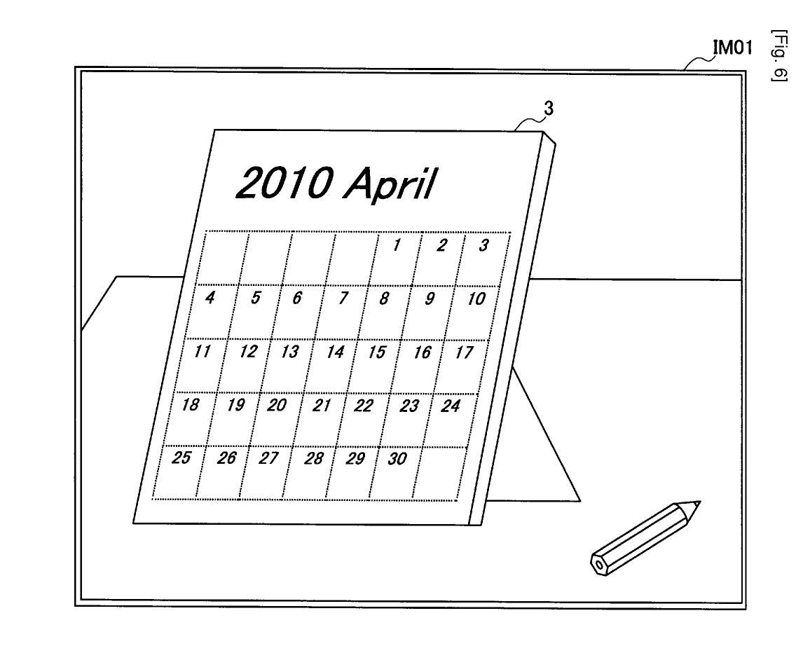

The Input image obtaining unit 130 obtains a series of input images imaged using the imaging device 102. FIG. 6 illustrates an input image IM01 as one example obtained by the input image obtaining unit 130. A calendar 3 is shown in the input image IM01. The input image obtaining unit 130 sequentially outputs such input image obtained to the calendar detection unit 140, the analyzing unit 150 and the gesture recognition unit 180.

(Calendar Detection Unit)

The calendar detection unit 140 detects a calendar shown in the input image input from the input image obtaining unit 130 using the above-described feature amount common to calendars 112 stored by the storage unit 110. More specifically, the calendar detection unit 140 firstly determines the feature amount of the input image as in the above-described learning processing. The feature amount of the input image includes, for example, coordinates of a plurality of feature points set in the input image. Next, the calendar detection unit 140 checks the feature amount of input image with the feature amount common to calendars 112, as a result of which, the calendar detection unit 140 detects a calendar shown in the input image.

The calendar detection unit 140 may further detect, for example, a direction of a calendar shown in the input image. When detecting a direction of a calendar shown in the input image, the calendar detection unit 140 uses the feature amount common to calendars including a plurality sets of feature amount which correspond to a plurality of eye directions, respectively.

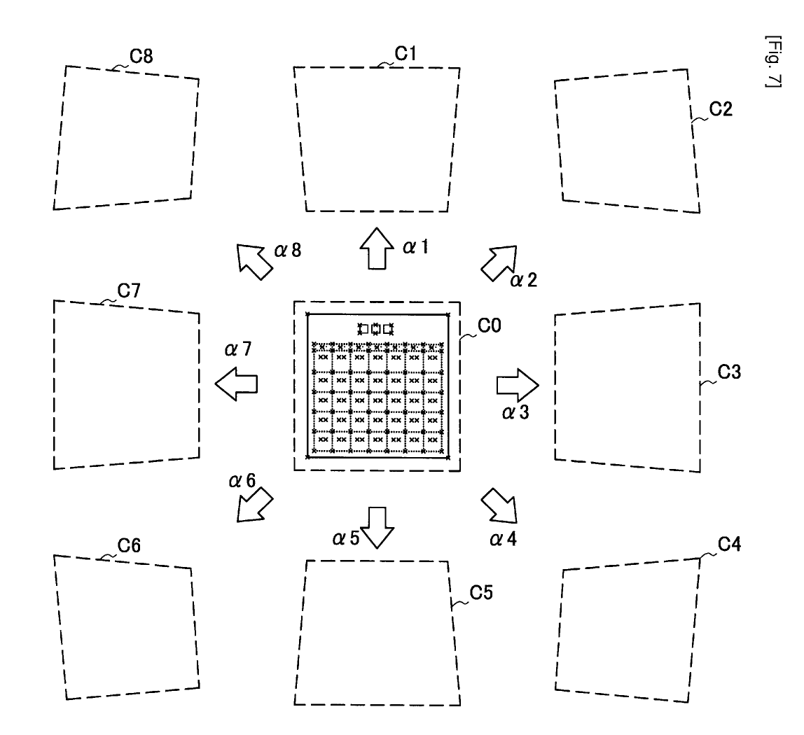

FIG. 7 is an illustrative view showing one example of sets of feature amount corresponding to eye directions. In the center of FIG. 7, a calendar C0 illustrating an appearance of an abstract calendar (a basic set of feature amount) is illustrated. The calendar C0 is rendered using the feature amount learned, assuming that a calendar image obtained by imaging from the front side and a non-calendar image as a teacher image. The calendar detection unit 140 subjects, to an affine conversion, the coordinate of feature points included in such feature amount common to calendars 112 or subject 3D rotation to the coordinate to generate a plurality of sets of feature amount which correspond to a plurality of eye directions, respectively. In an example of FIG. 7, eight sets of feature amount C1 to C8 which correspond to eye directions alpha 1 to alpha 8, respectively are illustrated. The calendar detection unit 140, therefore, checks, for example, the basic set of feature amount C0 and each of sets of the feature amount C1 to C8 with the feature amount of the input image. In this case, if the feature amount set C4 matches a specific region in the input image, the calendar detection unit 140 may recognize that the calendar is shown in the region and a direction of the calendar corresponds to a direction of an eye direction alpha 4.

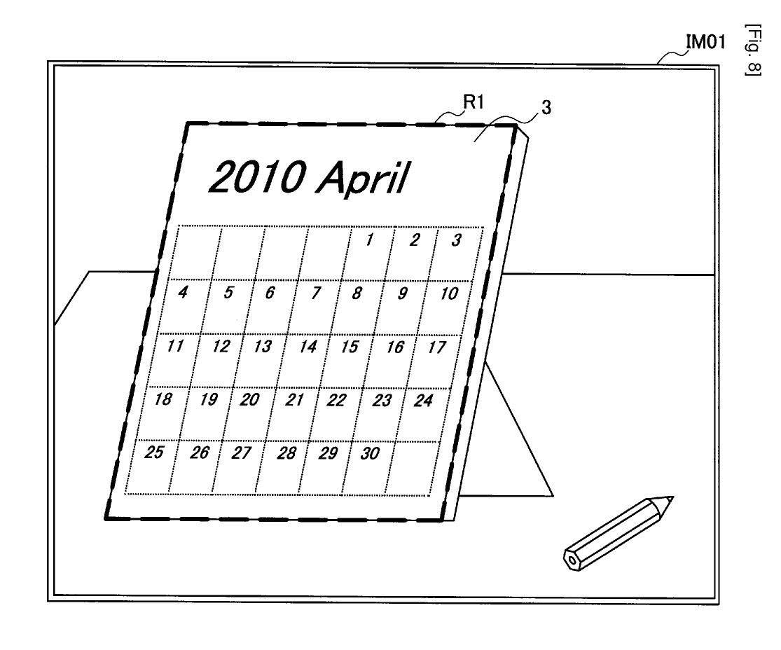

FIG. 8 is an illustrative view showing one example of result of detection of the calendar. Referring to FIG. 8, a dotted line frame is illustrated in a region R1 within the input image IMO 1 where the calendar 3 is shown. The input image IM01 is obtained by imaging the calendar 3 from an eye direction different from a front direction of the calendar 3. The calendar detection unit 140 recognizes position and a direction of the calendar 3 in such input image IM01 as a result of the check of a plurality of sets of feature amount exemplified in FIG. 7 with the feature amount of the input image.

(Analyzing Unit)

The analyzing unit 150 analyzes where each date of the calendar detected by the calendar detection unit 140 is positioned in the image. More specifically, the analyzing unit 150 recognizes at least one of a month, days of the week and dates indicated by the calendar detected by the calendar detection unit 140 using, for example, OCR (Optical Character Recognition) technology. For example, the analyzing unit 150 firstly applies optical character recognition (OCR) to a region of the calendar (for example, a region R1 illustrated in FIG. 8) in the input image detected by the calendar detection unit 140. In an example of FIG. 8, by applying the optical character recognition (OCR), a label indicating a year and month of the calendar 3, “2010 April” and numerals in a frame of each date may be read. As a result, the analyzing unit 150 may recognize that the calendar 3 is a calendar of April 2010 and recognize where a frame of each date of the calendar 3 is positioned in the input image.

Moreover, the analyzing unit 150 may analyze where each date of a calendar detected by the calendar detection unit 140 is positioned in the image based on, for example, knowledge about dates and days of the week of each year and month. More specifically, for example, it is known that Apr. 1, 2010 is Thursday. The analyzing unit 150 may, therefore, recognize a frame of each date from the coordination of feature points on the calendar 3 and recognize where “Apr. 1, 2010” is positioned even if it may not read numerals in a frame of each date using an optical character recognition (OCR). Moreover, the analyzing unit 150 may estimate a year and month based on position of the date recognized using, for example, the optical character recognition (OCR).

### (Output Image Generation Unit)

An output image generation unit 160 generates an output image obtained by associating one or more information elements included in schedule data in the form of a list of dated information with a date corresponding to each information element and superimposing the associated information elements on a calendar based on results of analysis by the analyzing unit 150. In that case, the output image generating unit 160 may vary the display of information elements included in the schedule data in the output image in accordance with the direction of the calendar detected by the calendar detection unit 140.

(Schedule Data)

FIG. 9 illustrates one example of schedule data 119 stored by the storage unit 110.

Referring to FIG. 9, the schedule data 116 has five fields: “owner”, “date”, “title”, “category” and “details”.

“Owner” means a user who generated each schedule item (each record of schedule data). In an example of FIG. 9, an owner of the schedule items No. 1 to No. 3 is a user Ua. Moreover, an owner of the fourth schedule item is a user Ub.

“Date” means a date corresponding to each schedule item. For example, the first schedule item indicates schedule of Apr. 6, 2010. The “date” field may indicate a period with a commencing date and an end date instead of a single date.

“Title” is formed by a character string indicating contents of schedule described in each schedule item straight. For example, the first schedule item indicates that a group meeting is held on Apr. 6, 2010.

“Category” is a flag indicating whether each schedule item is to be disclosed to users other than an owner or not. The schedule item which is specified as “Disclosed” in the “Category” may be transmitted to other user's device depending on a user's gesture described later. On the other hand, the schedule item which is designated as “Undisclosed” in the “Category” is not transmitted to other user's device. For example, the second schedule item is specified as “Undisclosed”.

“Details” indicate details of schedule contents of each schedule item. For example, optional information element such as starting time of the meeting, contents of “to do” in preparation for the schedule may be stored in the “Details” field.

The output image generation unit 160 reads such schedule data from the storage unit 110 and associates information element such as title or owner included in the read schedule data with a date corresponding to each information element in the output image.

(Display Unit)

A display unit 170 displays the output image generated by the output image generation unit 160 to a user using the HMD 104.

(Examples of Output Image)

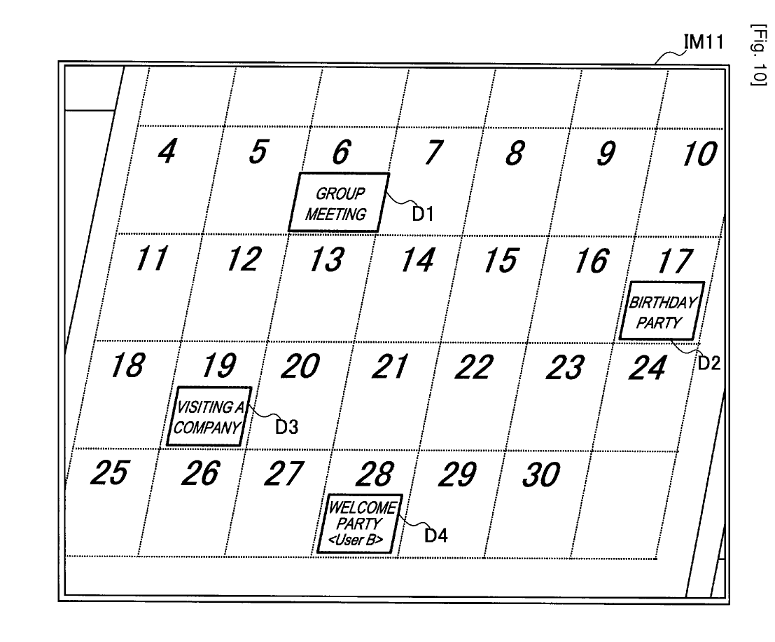

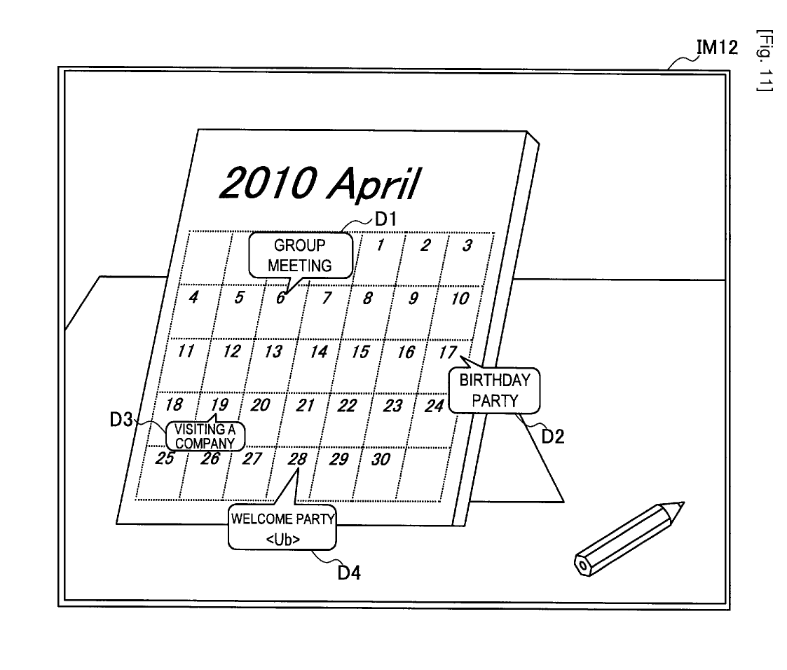

FIG. 10 and FIG. 11 display an example of the output image generated by the output image generation unit 160, respectively. An output image IM11 illustrated in FIG. 10 is an example in which direction of display of the schedule item is inclined in accordance with direction of a calendar detected by the calendar detection unit 140. On the other hand, an output image IM12 illustrated in FIG. 11 is an example of display which does not depend on the direction of the calendar.

Referring to FIG. 10, four schedule items included in the schedule data 116 exemplified in FIG. 9 are displayed in the output image IM11 in a state where each of them is associated with the corresponding date. For example, a title of the first schedule item, namely “group meeting” is displayed in a frame of the 6th day (see D1). Further, a title of the second schedule item, namely “birthday party” is displayed in a frame of the 17th day (see D2). Further, a title of the third schedule item, namely “visiting A company” is displayed in a frame of the 19th day (see D3). Still further, a title of the fourth schedule item, namely “welcome party” and a name of a user who is an owner of the item, “Ub” are displayed in a frame of the 28th day (see D4). As they are all displayed in a state being inclined in accordance with the direction of the calendar 3, an image showing as if information were written in a physical calendar is provided to the user.

Referring to FIG. 11, four schedule items included in the schedule data 116 exemplified in FIG. 9 are displayed in the output image IM12 in a state where each of them is associated with the corresponding date in the same way. In an example illustrated in FIG. 11, each of schedule items is not inclined in accordance with the direction of the calendar 3 but is displayed using words balloon.

In examples as described in FIGS. 10 and 11, it is assumed that device which generated the output images IM11 or IM12 is the image processing device 100a. In that case, the above-described four schedule items are displayed to the user Ua by the image processing device 100a. On the other hand, the image processing device 100b does not display items other than schedule items generated by the user Ub except items to be transmitted from the image processing device 100a to the user Ub even when the user Ua and the user Ub see the same physical calendar 3. Therefore, the user Ua and the user Ub who share one physical calendar may discuss schedule without disclosing individual schedule to other party, while confirming it and pointing to the calendar depending on the situation.

Here, an owner of the first to the third schedule items exemplified in FIG. 9 is the user Ua and an owner of the fourth schedule item is the user Ub. A schedule item generated by a user different from a user of the device itself may be exchanged between image processing devices 100 depending on instructions from the user through an interface using a gesture or other user interfaces described next.

In addition, for example, if the HMD 104 is of a see-through type, the output image generation unit 160 generates only display D1 to D4 of each of schedule items to be superimposed on the calendar 3 as the output image. On the other hand, if the HMD 104 is of a non see-through type, the output image generation unit 160 generates an output image obtained by superimposing the display D1 to D4 of each of schedule items on the input image.

(Gesture Recognition Unit)

A gesture recognition unit 180 recognizes a user's real-world gesture toward a calendar which is detected by the calendar detection unit 140 in the input image. For example, the gesture recognition unit 180 may monitor a finger region superimposed on the calendar in the input image, detect variation in size of the finger region, and recognize that a specific schedule item has been designated. The finger region to be superimposed on the calendar may be detected through, for example, skin color or check with preliminarily stored finger image. In addition, for example, when the finger region of a size having more than a predetermined threshold value continuously points to the same date, the gesture recognition unit 180 may recognize that the user tapped the date at the moment a size of the finger region has become temporarily small. The gesture recognition unit 180 may additionally recognize arbitrary gestures other than a tap gesture, such as a gesture of making a circle around the circumference of one date with at finger tips or a gesture of dragging one schedule item at finger tips may be recognized. One of these gestures is preliminarily set as a command instructing transmission of the schedule item to other image processing device 100. Other types of gestures are preliminarily set as, for example, a command intrusting detailed display of the designated schedule item.

If the gesture recognition unit 180 recognizes a gesture set as a command instructing transmission of the schedule item among the user's gestures shown in the input image, it requests the communication unit 190 to transmit the designated schedule item.

(Communication Unit)

The communication unit 190 transmits data designated by a user among the schedule data of the user of the image processing device 100 to other image processing device 100. More specifically, for example, if a gesture instructing to transmit the schedule item has been recognized by the gesture recognition unit 180, the communication unit 190 selects the schedule item designated by the gesture and transmits the selected schedule item to other image processing device 100.

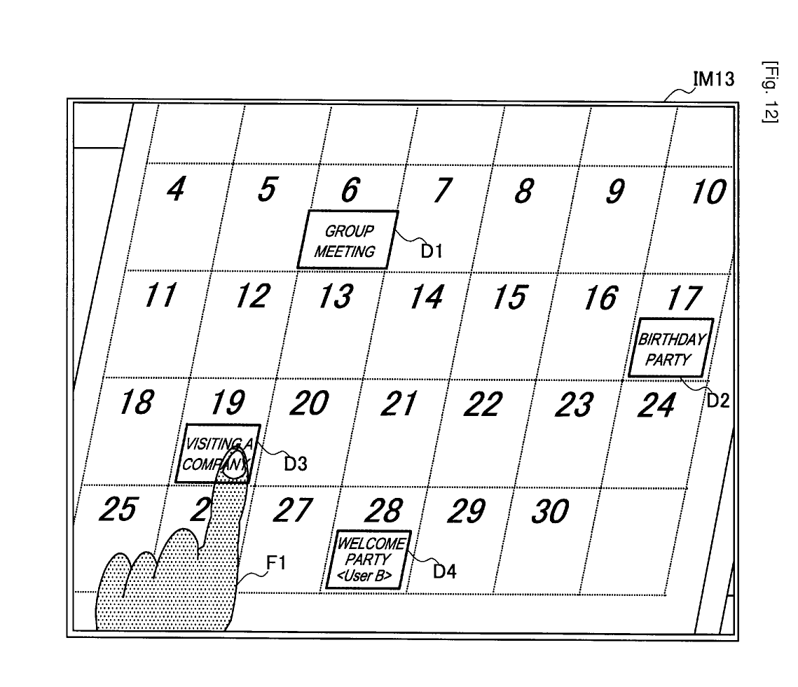

In an example of FIG. 12, the user's finger region F1 is shown in an output image IM13. In addition, although the finger region F1 is shown in the input image, the schedule items D1 to D4 are not shown in the input image, which is different from the output image IM13. In addition, for example, the gesture recognition unit 180 recognizes a gesture tapping an indication of a date of April 19, the communication unit 190 obtains the schedule item corresponding to the date of April 19 from the schedule data 116 of the storage unit 110. The communication unit 190 further checks the “Category” of the obtained schedule item. The communication unit 190 then transmits the schedule item to other image processing device 100 unless the obtained schedule item is designated as “Undisclosed” in the “Category”.

Further, the communication unit 190 receives the schedule item when the schedule item has been transmitted from other image processing device 100. The communication 190 then stores the received schedule item in the schedule data 116 of the storage unit 110. For example, the fourth schedule item in FIG. 9 is the schedule item received in the image processing device 100a of the user Ua from the image processing device 100b of the user Ub.

In this way, the schedule data may be transmitted and received among a plurality of image processing devices 100 in accordance with the user's gesture toward the calendar detected by the calendar detection unit 140, thus enabling to share the schedule easily. Moreover, information elements about the schedule to be shared is superimposed on a physical calendar by each of the image processing devices 100, which allows the user to coordinate the schedule easily without actually writing actually writing letters in a calendar.

<3. Image Processing Flow>

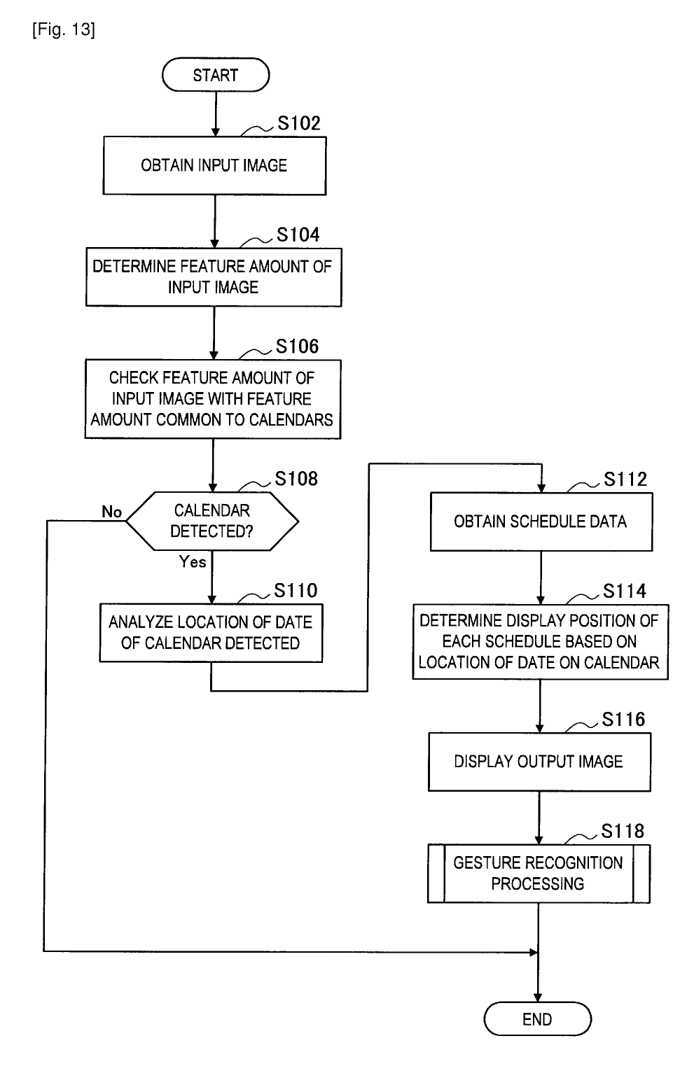

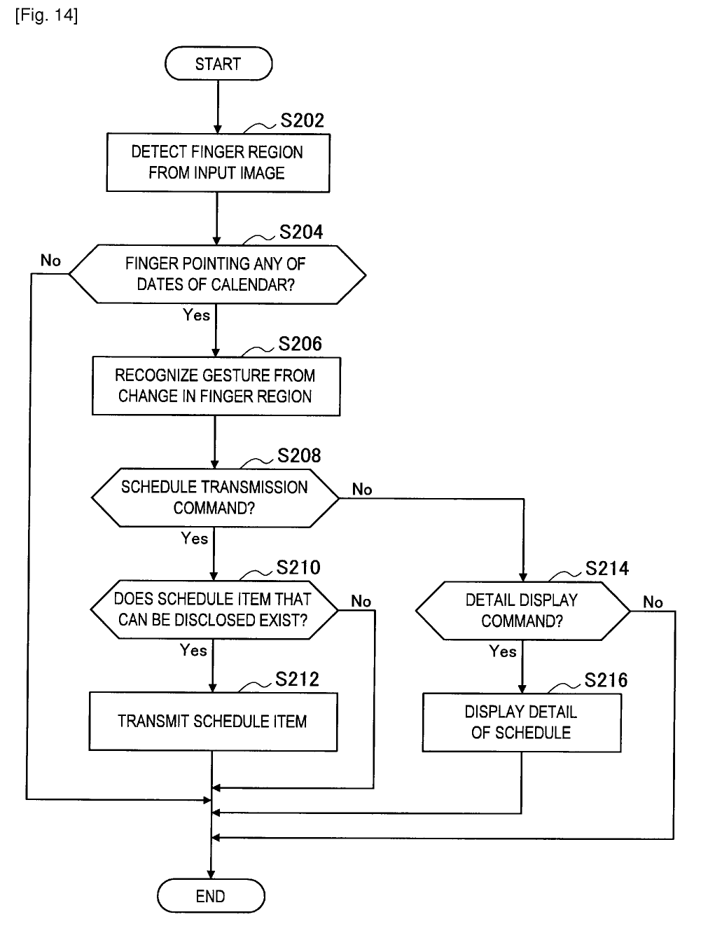

Subsequently, with reference to FIG. 13 and FIG. 14, an image processing flow performed by the image processing device 100 according to the present embodiment will be described. FIG. 13 is a flowchart illustrating an example of the image processing flow performed by the image processing device 100.

Referring to FIG. 13, the input image obtaining unit 130 firstly obtains an input image imaged by the imaging device 102 (Step S102). Subsequently, the calendar detection unit 140 sets a plurality of feature points in the input image obtained by the input image obtaining unit 130 and determines the feature amount of the input image (Step S104). Subsequently, the calendar detection unit 140 checks the feature amount of the input image with the feature amount common to calendars (Step S106). If a calendar has not been detected in the input image as a result of checking here, the subsequent processing will be skipped. On the other hand, if a calendar has been detected in the input image, the processing will proceed to Step S110 (Step S108).

If a calendar has been detected in the input image by the calendar detection unit 140, the analyzing unit 150 analyzes where a date of the calendar detected is positioned in the input image (Step S110). Subsequently, the output image generation unit 160 obtains the schedule data 116 from the storage unit 110 (Step S112). Subsequently, the output image generation unit 160 determines where each schedule item included in the schedule data is displayed based on the position of a date on the calendar as a result of the analysis by analyzing unit 150 (Step S114). The output image generation unit 160 then generates an output image obtained by superimposing each schedule item at the determined position of display and causes the display unit 170 to display the generated output image (Step S116).

Thereafter, a gesture recognition processing will be further performed by the gesture recognition unit 180 (Step S118). The gesture recognition processing flow performed by the gesture recognition unit 180 will be further described with reference to FIG. 14.

The image processing illustrated in FIG. 13 will be repeated for each of a series of the input images obtained by the input image obtaining unit 130. If results of the image processing in the previous frame may be reutilized, for example, when the input image has not been changed from that of the previous frame, part of the image processing illustrated in FIG. 13 may be omitted.

FIG. 14 is a flowchart illustrating one example of the detailed flow of the gesture recognition processing among the image processing performed by the image processing device 100.

Referring to FIG. 14, the gesture recognition unit 180 firstly detects a finger region from the input image (Step S202). The gesture recognition unit 180 then determines whether the user's finger points to any date of the calendar or not in accordance with the position of the detected finger region (Step S204). If the user's finger does not point to any date of the calendar here, or the finger region of a size having more than a predetermined threshold value has not been detected, the subsequent processing will be skipped. On the other hand, if the user's finger points to any date of the calendar, the processing will proceed to Step S206.

The gesture recognition unit 180 then recognizes the user's gesture based on variation in the finger regions across a plurality of input images (Step S206). The gesture recognized here may be a tap gesture, etc. exemplified above. Subsequently, the gesture recognition unit 180 determines whether the recognized gesture is a gesture corresponding to a schedule transmission command or not (Step S208). If the gesture recognized here is a gesture corresponding to a schedule transmission command, the communication unit 190 obtains the schedule item that can be disclosed among the schedule items corresponding to a date designated by the gesture. The schedule item that can be disclosed is an item that is designated as “disclosed” in the “Category” in the schedule data 116. If no scheduled item that can be disclosed exists here, the subsequent processing will be skipped (Step S210). On the other hand, if the schedule item that can be disclosed which corresponds to the date designated by the gesture exits, the communication unit 190 transmits the schedule item to other image processing device 100 (Step S212).

If the gesture recognized in Step S206 is not a gesture corresponding to the schedule transmission command, the gesture recognition unit 180 determines if the recognized gesture is a gesture corresponding to the detailed display command or not (Step S214).

If the recognized gesture is a gesture corresponding to the detailed display command here, details of the schedule item designated by the gesture are displayed by the output image generation unit 160 and the display unit 170 (Step S216). On the other hand, if the recognized gesture is not a gesture corresponding to the detailed display command, the gesture recognition processing terminates.

In addition, although an example in which transmission of the schedule item and display of details thereof are instructed by the user's gesture has been shown with reference to FIG. 14, operations of the image processing device 100 other than the above may be instructed by a gesture. The image processing device 100 may further recognize instructions from the user in accordance with motions of objects other than fingers in the input image. The image processing device 100 may further accept instructions from the user via input means that are additionally provided in the image processing device 100, such as a key pad or a ten-key pad.

<4. Summary>

So far, with reference to FIGS. 1 to 14, the image processing system 1 and the image processing device 100 according to one embodiment have been described. According to the present embodiment, a calendar shown in the input image is detected using feature amount common to calendars indicating feature in appearance common to a plurality of calendars. Additionally, it is analyzed where each date of the calendar detected is positioned in the image, and information elements included in the schedule data is displayed in a state of being associated with a date on the calendar which corresponds to the information elements. As a result, it is possible for a user to confirm schedule easily using a physical calendar without any restriction imposed on the electronic equipment. Even when a plurality of users refer to one physical calendar, they may coordinate schedules easily without actually writing letters in the calendar as individual schedule is displayed to each user.

Further in the present embodiment, the image processing device 100 may transmit only the schedule item indicating schedule that is not disclosed among schedules of the user of the device itself to other image processing device 100. Therefore, when the users share schedules, an individual user's private schedule will not be disclosed to other users, which is different from a case where they open their appointment books in which their schedules are written.

Further in the present embodiment, the feature amount common to calendars is feature amount including a coordinate of a plurality feature points set on an appearance of an abstract calendar. Many of commonly used calendars are similar in appearance. For this reason, even when not feature amount of an individual calendar but the feature amount common to calendars is preliminarily determined, the image processing device 100 may flexibly detect many of real-world various calendars by checking the feature amount common to calendars with feature amount of the input image. The user may, therefore, confirm the schedule on various calendars, for example, his/her calendar at home, his/her office calendar and a calendar of a company to be visited, enjoying advantages of the disclosed embodiments.

Further in the present embodiment, the image processing device 100 detects the calendar in the input image using a plurality of sets of feature amount corresponding to a plurality of eye directions, respectively. As a result, even when the user is not positioned in front of the calendar, the image processing device 100 may appropriately detect the calendar to a certain degree.

In addition, the present specification mainly described an example in which the gesture recognition unit 180 recognizes a user's gesture shown in the input image so that the image processing device 100 may accept instructions from the user. However, the image processing device 100 may accept instructions from the user via input means provided in the image processing device 100, such as a pointing device or a touch panel instead of the user's gesture.

Moreover, a series of processing performed by the image processing device 100 described in the present specification may be typically realized using a software. A program configuring a software realizing a series of processing is preliminarily stored in, for example, a tangibly embodied non-transitory storage medium provided inside or outside the image processing device 100. Each program is then read in, for example, RAM (Random Access Memory) of the image processing device 100 during execution and executed by a processor such as a CPU (Central Processing Unit).

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

100 Image processing device
102 Image processing device
104 HMD
110 Storage unit
112 Feature amount common to calendars
116 Schedule data
130 Input image obtaining unit
140 Calendar detection unit
150 Analyzing unit
160 Output image generation unit
190 Communication unit

1. An apparatus, comprising:
a receiving unit for receiving image data representing an input image;
a detecting unit for detecting the presence of a temporal measurement object in the input image based on features of the temporal measurement object detected in the image data; and
an output device for outputting, in response to detection of the presence of the temporal measurement object in the input image, schedule data for superimposing on a user's view of the temporal measurement object.

2. The apparatus of claim 1, wherein the temporal measurement object is a calendar object, and the schedule data comprises schedule data associated with a user.

3. The apparatus of claim 2, comprising:
an analyzing unit for analyzing the image data to detect calendar features corresponding to calendar objects stored in a storage unit.

4. The apparatus of claim 3, wherein the calendar features comprise calendar features corresponding to a plurality of viewing angles of the user.

5. The apparatus of claim 4, wherein a perspective of the superimposed schedule data is selected to correspond to an angle of the user's view of the calendar object.

6. The apparatus of claim 5, wherein the user's view of the calendar object is determined in accordance with positions of the detected calendar features.

7. The apparatus of claim 2, wherein the user is a first user and the apparatus comprises:
a communication unit for sharing the data with the second user by communicating the schedule data to a receiving apparatus associated with a second user.

8. The apparatus of claim 7, wherein the communication unit communicates the schedule data to the receiving apparatus in response to detecting a gesture of at least one of the first user or the second user toward the calendar object.

9. A method comprising:
receiving image data representing an input image;
detecting the presence of a temporal measurement object in the input image based on features of the temporal measurement object detected in the image data; and
providing, in response to detection of the presence of the temporal measurement object in the input image, schedule data for superimposing on a user's view of the temporal measurement object.

10. A tangibly embodied non-transitory computer-readable storage medium storing instructions, which when executed by a processor, causes a computer to perform a method comprising:
receiving image data representing an input image;
detecting the presence of a temporal measurement object in the input image based on features of the temporal measurement object detected in the image data; and
providing, in response to detection of the presence of the temporal measurement object in the input image, schedule data for superimposing on a user's view of the temporal measurement object.

11. An apparatus, comprising:
a first receiving unit for receiving image data representing an input image, the input image including a temporal measurement object;
a second receiving unit for receiving schedule data for superimposing on a user's view of the temporal measurement object; and
a generating unit for generating display information for displaying the received schedule data superimposed on the user's view of the temporal measurement object.

12. A system comprising:
an image processing unit configured to obtain image data representing an input image, and to generate display information of schedule data superimposed on a user's view of a temporal measurement object; and
a detecting unit configured to detect the presence of a temporal measurement object in the input image based on features of the temporal measurement object in the image data, and to provide, in response to detection of the presence of the temporal measurement object in the input image, schedule data to the image processing apparatus for superimposing on the user's view of the temporal measurement object.
